(19) United States
(12) Patent Application Publication
(10) Pub. No.: US 2014/0120421 A1
(43) Pub. Date: May 1, 2014

(54) ALL-SOLID BATTERY AND MANUFACTURING METHOD THEREFOR

(71) Applicant: MURATA MANUFACTURING CO., LTD., Nagaokakyo-Shi (JP)

(72) Inventors: Masutaka Ouchi, Nagaokakyo-Shi (JP); Makoto Yoshioka, Nagaokakyo-Shi (JP); Takeshi Hayashi, Nagaokakyo-Shi (JP)

(73) Assignee: MURATA MANUFACTURING CO., LTD., Nagaokakyo-Shi (JP)

(21) Appl. No.: 14/150,062

(22) Filed: Jan. 8, 2014

Related U.S. Application Data
(63) Continuation of application No. PCT/JP2012/066951, filed on Jul. 3, 2012.

(30) Foreign Application Priority Data
Jul. 8, 2011 (JP) 2011-151747

(51) Int. Cl. H01M 10/058

(52) U.S. Cl. CPC H01M 10/058
USPC 429/211; 29/623.1

(57) ABSTRACT

A method for manufacturing an all-solid battery that includes: preparing a first green sheet for at least any one of a positive electrode layer and a negative electrode layer, preparing a second green sheet for at least any one of a solid electrolyte layer and a current collector layer; and stacking the first green sheet and the second green sheet to form a stacked body while applying pressure so that the stacked body has an elongation percentage of 2.0% or less in the planar direction of the first and second green sheets.

### CROSS REFERENCE TO RELATED APPLICATIONS

The present application is a continuation of International application No. PCT/JP2012/066951, filed Jul. 3, 2012, which claims priority to Japanese Patent Application No. 2011-151747, filed Jul. 8, 2011, the entire contents of each of which are incorporated herein by reference.

### FIELD OF THE INVENTION

The present invention relates to an all-solid battery and a method for manufacturing the all-solid battery.

### BACKGROUND OF THE INVENTION

In recent years, the demand has been substantially expanded for batteries as power sources for portable electronic devices such as cellular phones and portable personal computers. In the batteries for use in such applications, electrolytes (electrolytic solutions) such as organic solvents have been conventionally used as media for moving ions.

However, the batteries configured above are at risk of causing the electrolytic solutions to leak out. In addition, the organic solvents or the like for use in the electrolytic solutions are flammable materials. For this reason, there has been a need to further increase the safety of the batteries.

Therefore, as one of countermeasures for increasing the safety of the batteries, it has been proposed that solid electrolytes are used as the electrolytes, in place of electrolytic solutions. Furthermore, the development of all-solid batteries which use solid electrolytes as the electrolytes and have other constituent elements also composed of solids has been advanced.

For example, Japanese Patent Application Laid-Open No. 2007-227362 (hereinafter, referred to as Patent Document 1) proposes a method for manufacturing an all-solid battery which has constituent elements all composed of solids with the use of a non-flammable solid electrolyte. The method disclosed in Patent Document 1 for manufacturing an all-solid battery includes: a step of forming respective green sheets for a solid electrolyte, an active material, and a current collector; a green sheet group preparation step of stacking the obtained green sheets to prepare a green sheet group; a heating step of heating the green sheet group; and a firing step of firing the heated green sheet group to obtain a stacked body including a solid electrolyte layer, an active material layer, and a current collector layer.
Patent Document 1: Japanese Patent Application Laid-Open No. 2007-227362

### SUMMARY OF THE INVENTION

As a result of various studies carried out by the inventors on methods for manufacturing an all-solid battery as described in Patent Document 1, it was found that there is a need to apply pressure when green sheets are stacked to form a green sheet group (a stacked body of green sheets). However, it was found that when pressure is applied to form a stacked body of green sheets, the internal resistance of the all-solid battery is increased to decrease the battery capacity, because the stacked body is stretched in the planar direction of the green sheets. The present invention has been achieved on the basis of the finding mentioned above.

Therefore, an object of the present invention is to provide a method for manufacturing an all-solid battery that is able to suppress an increase in the internal resistance of the all-solid battery, and an all-solid battery manufactured by the method.

As a result of various studies made by the inventors in order to solve the problem mentioned above, it has been found that the increase in the internal resistance of an all-solid battery can be suppressed by limiting the elongation percentage of a stacked body of green sheets to less than or equal to a predetermined value. On the basis of this finding of the inventors, the present invention has the following features.

A method for manufacturing an all-solid battery in accordance with one aspect of the present invention includes the following steps.

(A) Green sheet preparation step of preparing a green sheet for at least any one of a positive electrode layer, a negative electrode layer, a solid electrolyte, and a current collector layer.

(B) Stacked body formation step of stacking the green sheet to form a stacked body.

(C) The stacked body formation step includes stacking the green sheet and applying pressure so that the stacked body has an elongation percentage of 2.0% or less in the planar direction of the green sheet.

A method for manufacturing an all-solid battery in accordance with another aspect of the present invention includes the following steps.

(D) Green sheet preparation step of preparing a first green sheet as a green sheet for at least any one of a positive electrode layer and a negative electrode layer, and a second green sheet as a green sheet for at least any one of a solid electrolyte layer and a current collector layer.

(E) Stacked body formation step of stacking the first green sheet and the second green sheet to form a stacked body.

(F) The stacked body formation step includes stacking the first green sheet and the second green sheet and applying pressure so that the stacked body has an elongation percentage of 2.0% or less in the planar direction of the first and second green sheets.

The stacked body formation step preferably includes stacking the first green sheet and the second green sheet through a planar member of 0.21 μmRa or more and 2.03 μmRa or less in surface roughness, and applying pressure for each stacking, or forming a stacked body through a planar member of 0.21 μmRa or more and 2.03 μmRa or less in surface roughness, and applying pressure to the stacked body.

The stacked body formation step may be carried out with the first green sheet and second green sheet housed in a rigid container.

In the stacked body formation step, pressure may be applied to the stacked body by isostatic pressing.

In the stacked body formation step, a pressure of 500 kg/cm² or more and 5000 kg/cm² or less is preferably applied to the first green sheet and second green sheet, or to the stacked body.

In the stacked body formation step, the pressure is preferably applied to the first green sheet and second green sheet, or to the stacked body, while keeping a temperature of 20° C. or higher and 100° C. or lower.

In the stacked body formation step, green sheets for the positive electrode layer, the solid electrolyte layer, and the negative electrode layer are preferably stacked to form a stacked body which has an electrical cell structure.

Furthermore, in the stacked body formation step, more than one of the stacked body which has the electrical cell structure may be stacked to form a stacked body, while interposing a green sheet for the current collector layer.

The method for manufacturing an all-solid battery according to the present invention preferably further includes a firing step of firing the stacked body.

In the firing step, the stacked body is preferably subjected to firing while pressure is applied.

In the method for manufacturing an all-solid battery according to the present invention, at least one material for the positive electrode layer, solid electrolyte layer, or negative electrode layer preferably contains a solid electrolyte composed of a lithium-containing phosphate compound which has a NASICON-type structure.

In the method for manufacturing an all-solid battery according to the present invention, at least one material for the positive electrode layer or negative electrode layer preferably contains an electrode active material composed of a lithium-containing phosphate compound.

An all-solid battery in accordance with the present invention is manufactured by the manufacturing method including the features mentioned above.

The method for manufacturing an all-solid battery according to the present invention can suppress the increase in the internal resistance of the all-solid battery by limiting the elongation percentage of the stacked body of green sheets to less than or equal to a predetermined value, and thus can increase the battery capacity.

### BRIEF EXPLANATION OF THE DRAWINGS

FIG. 1 is a cross-sectional view schematically illustrating a cross-section structure of an all-solid battery as one embodiment through the application of a manufacturing method according to the present invention.

FIG. 2 is a cross-sectional view schematically illustrating a cross-section structure of an all-solid battery as another embodiment through the application of the manufacturing method according to the present invention.

FIG. 3 is a cross-sectional view schematically illustrating one embodiment of a stacked body formation step in the manufacturing method according to the present invention.

FIG. 4 is a cross-sectional view schematically illustrating another embodiment of the stacked body formation step in the manufacturing method according to the present invention.

FIG. 5 is a cross-sectional view schematically illustrating still another embodiment of the stacked body formation step in the manufacturing method according to the present invention.

FIG. 6 is a perspective view illustrating external dimensions of a stacked body prepared according to an example of the present invention.

### DETAILED DESCRIPTION OF THE INVENTION

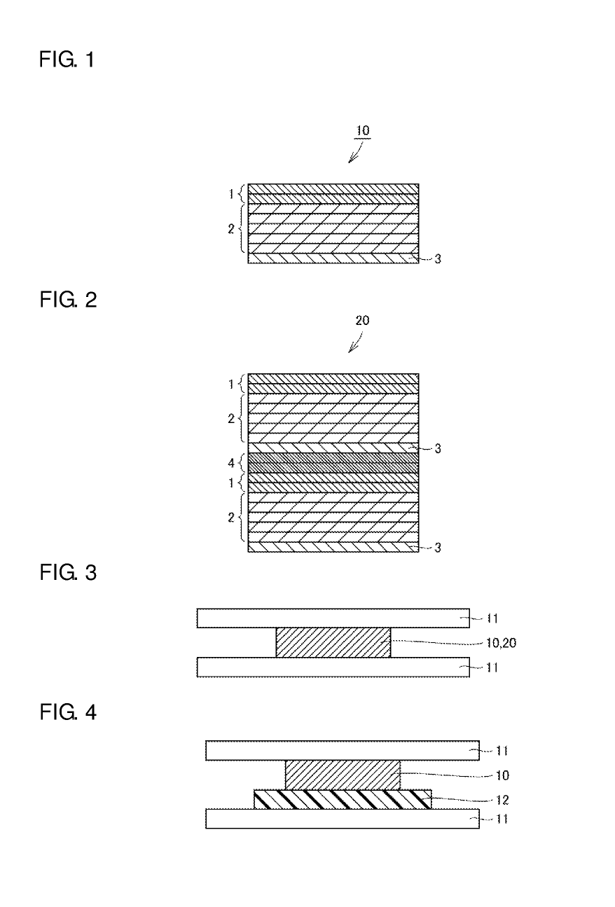

As shown in FIG. 1, a stacked body 10 of an all-solid battery as one embodiment through the application of a manufacturing method according to the present invention is composed of an electrical cell including a positive electrode layer 1, a solid electrolyte layer 2, and a negative electrode layer 3. The positive electrode layer 1 is placed on one surface of the solid electrolyte layer 2, whereas the negative electrode layer 3 is placed on the other surface on the side opposite to the one surface of the solid electrolyte layer 2. In other words, the positive electrode layer 1 and the negative electrode layer 3 are provided in positions opposed to each other with the solid electrolyte layer 2 interposed therebetween.

As shown in FIG. 2, for a stacked body 20 of an all-solid battery as another embodiment through the application of the manufacturing method according to the present invention, more than one, for example, two electrical cells each composed of a positive electrode layer 1, a solid electrolyte layer 2, and a negative electrode layer 3 are connected in series with a current collector layer 4 interposed therebetween. The current collector layer 4 placed within the stacked body 20 of the all-solid battery is provided between the positive electrode layer 1 and the negative electrode layer 3.

It is to be noted that each of the positive electrode layer 1 and the negative electrode layer 3 contains a solid electrolyte and an electrode active material, whereas the solid electrolyte layer 2 contains a solid electrolyte. Each of the positive electrode layer 1 and the negative electrode layer 3 may contain a carbon material, a metal material, etc. as an electron conducting material.

In order to manufacture the stacked body 10 or 20 of the all-solid battery configured as described above, according to the present invention, first, a green sheet is prepared for at least any one of the positive electrode layer 1, negative electrode layer 3, solid electrolyte layer 2, and current collector layer 4, or a first green sheet as a green sheet for at least any one of the positive electrode layer 1 and negative electrode layer 3 and a second green sheet as a green sheet for at least any one of the solid electrolyte layer 2 and current collector layer 4 are prepared (green sheet preparation step). Thereafter, the prepared green sheet is stacked, or the prepared first green sheet and second green sheet are stacked to form the stacked body 10 or 20 (stacked body formation step). In this stacking step, the green sheet is stacked, or the first green sheet and second green sheet are stacked, and subjected to application of pressure so that the stacked body 10 or 20 has an elongation percentage of 2.0% or less in the planar direction of the green sheet, or the first and second green sheets. Thereafter, the stacked body 10 or 20 is subjected to firing in some cases (firing step).

When the green sheets are stacked to form the stacked body 10 or 20, the green sheets stretched in the planar direction make cracks more likely to be produced within the green sheets, although the reason is not known exactly. It is estimated that when this stacked body 10 or 20 is used to prepare an all-solid battery, the ion-conducting path or electron-conducting path will be blocked off in the cracked parts to increase the internal resistance of the all-solid battery. Furthermore, in the case of a sintered-type all-solid battery, sintering is not progressed in the cracked parts to generate spaces within the battery. The spaces make it impossible to maintain the strength of the all-solid battery.

According to the present invention, the cracks are less likely to be produced, because the green sheets are stacked in such a way that the elongation percentage in the planar direction of the green sheets is controlled to 2.0% or less in the stacked body formation step. For this reason, the increase in the internal resistance of the all-solid battery can be suppressed. In this way, the increase in the internal resistance of the all-solid battery can be suppressed by limiting the elongation percentage of the stacked body of green sheets to less than or equal to a predetermined value in the stacked body formation step, and the battery capacity can be thus increased.

It is to be noted that the elongation percentage is preferably 0.1% or more. The elongation percentage less than 0.1% makes it almost impossible to move particles of, for example, the electrode active material and solid electrolyte included in the green sheets in the planar direction of the green sheets, thus possibly making it difficult to obtain the densely packed electrode active material and solid electrolyte included in the green sheets in the stacked body formation step.

In the stacked body formation step, pressure is preferably applied to the first green sheet and second green sheet, through a flat plate of 0.21 μmRa or more and 2.03 μmRa or less in surface roughness. By staking the green sheets in this manner through the flat plate of 0.21 μmRa or more in surface roughness, stretching of the green sheets can be suppressed and the green sheets can be firmly attached to each other. In addition, by stacking the green sheets to form the stacked body 10 or 20 in advance and then applying pressure to the stacked body 10 or 20 through a flat plate of 0.21 μmRa or more in surface roughness, stretching of the stacked body 10 or 20 can be suppressed and the green sheets can be firmly attached to each other.

Through a film of 0.21 μmRa or more and 2.03 μmRa or less in surface roughness, pressure may be applied by plate pressing or the like to the green sheets or to the stacked body 10 or 20. In this case, organic materials such as polyester, paper, and the like can be used as the film material. In addition, when the green sheets are stacked with the use of a flat plate or film of larger than 2.03 μmRa in surface roughness, the surface of the stacked body 10 or 20 may be roughened in some cases. Thus, it is preferable to use a flat plate or a film that is 0.21 μmRa or more and 2.03 μmRa or less in surface roughness.

It is to be noted that as the surface roughness, the value of the center line average roughness is used which is calculated by providing the x axis along the surface of the flat plate or film, expressing the magnitude of asperity at a coordinate x in terms of f(x), and dividing the product of the length L within a predetermined interval on the x axis and |f(x)| by the length L.

In the stacked body formation step, pressure may be added to the first green sheet and the second green sheet, with the first green sheet and second green sheet housed in a rigid container. In this case, when the green sheets are stacked and applied with pressure while housed in a rigid container, for example, a metallic container which preferably has substantially the same internal dimensions as those of the stacked body 10 or 20, stretching of the green sheets can be suppressed, and the green sheets can be firmly attached to each other. In addition, by stacking the green sheets to form the stacked body 10 or 20 in advance and then housing the stacked body 10 or 20 in the metallic container to apply pressure to the stacked body 10 or 20, stretching of the stacked body 10 or 20 can be suppressed and the green sheets can be firmly attached to each other.

In the stacked body formation step, pressure may be applied to the stacked body 10 or 20 by isostatic pressing. As just described, by stacking the green sheets to form the stacked body 10 or 20 in advance and then applying pressure to the stacked body 10 or 20 by isostatic pressing, stretching of the stacked body 10 or 20 can be suppressed and the green sheets can be firmly attached to each other.

It is to be noted that, in the stacked body formation step, a pressure of 500 kg/cm² or more and 5000 kg/cm² or less is preferably applied to the first green sheet and second green sheet, or to the stacked body 10 or 20. In addition, in the stacked body formation step, the pressure is preferably applied to the first green sheet and second green sheet, or to the stacked body 10 or 20, while keeping a temperature of 20° C. or higher and 100° C. or lower. The application of the pressure with the temperature kept in the range mentioned above softens the resin contained in the green sheet to make the green sheets can readily be firmly attached to each other.

In the stacked body formation step, green sheets for the positive electrode layer 1, the solid electrolyte layer 2, and the negative electrode layer 3 are preferably stacked to form the stacked body 10 which has an electrical cell structure. Furthermore, in the stacked body formation step, a stacked body 20 may be formed by stacking more than one stacked body 10 which has the electrical cell structure while a green sheet for a current collector is interposed therebetween. In this case, more than one stacked body 10 which has the electrical cell structure may be stacked electrically in series or in parallel.

In a case that a firing step is included, the stacked body is preferably subjected to firing while pressure is applied. When the stacked body 10 or 20 is subjected to firing while pressure is applied, the positive electrode layer 1 or negative electrode layer 3 and the solid electrolyte layer 2 are readily joined by sintering without any space therebetween.

While the method for forming the green sheets is not particularly limited, a die coater, a comma coater, screen printing, etc. can be used. While the method for stacking the green sheets is not particularly limited, hot isostatic pressing (HIP), cold isostatic pressing (CIP), water isostatic pressing (WIP), etc. can be used to stack the green sheets.

Slurry for forming the green sheets can be prepared by wet mixing, an organic vehicle with a polymer material dissolved in a solvent, with a positive electrode active material, a negative electrode active material, a solid electrolyte, or a current collector material. In the wet mixing, media can be used, and specifically, a ball mill method, a visco mill method, etc. can be used. On the other hand, wet mixing methods may be used which use no media, and a sand mill method, a high-pressure homogenizer method, a kneader dispersion method, etc. can be used.

The slurry may contain a plasticizer. While the type of the plasticizer is not particularly limited, phthalates and the like may be used such as dioctyl phthalate and diisononyl phthalate.

While the atmosphere is not particularly limited in the firing step, the firing step is preferably carried out under the condition that the transition metal contained in the electrode active material undergoes no change in valence.

It is to be noted that while the type of the electrode active material is not limited which is contained in the positive electrode layer 1 or negative electrode layer 3 of the stacked body 10 or 20 of the all-solid battery through the application of the manufacturing method according to the present invention, lithium-containing phosphate compounds which have a NASICON-type structure such as Li₃V₂(PO₄)₃, lithium-containing phosphate compounds which have an olivine-type structure such as LiFePO₄ and LiMnPO₄, layered compounds such as LiCoO₂ and LiCo_{1/3}Ni_{1/3}Mn_{1/3}O₂, and lithium-containing compounds which have a spinel-type structure such as LiMn₂O₄ and LiNi_{0.5}Mn_{1.5}O₄ can be used as the positive electrode active material.

Compounds which have a composition represented by MOx (M is at least one or more elements selected from the group consisting of Ti, Si, Sn, Cr, Fe, and Mo, and x is a numerical value in the range of 0.9≦x≦2.0) can be used as the negative electrode active material. For example, a mixture may be used which is obtained by mixing two or more active materials containing different elements M, which have compositions represented by MOx, such as TiO₂ and SiO₂. In addition, carbon materials, graphite-lithium compounds, lithium alloys such as Li—Al, oxides such as Li₃V₂(PO₄)₃, Li₃Fe₂(PO₄)₃, and Li₄Ti₅O₁₂, etc. can be used as the negative electrode active material.

In addition, while the type of the solid electrolyte is not limited which is contained in the positive electrode layer 1, negative electrode layer 3 or solid electrolyte layer 2 of the stacked body 10 or 20 of the all-solid battery through the application of the manufacturing method according to the present invention, lithium-containing phosphate compounds which have a NASICON-type structure can be used as the solid electrolyte. The lithium-containing phosphate compounds which have a NASICON-type structure are represented by the chemical formula LiₓM_{y}(PO₄)₃ (in the chemical formula, x and y are respectively numerical values in the ranges of 1≦x≦2 and 1≦y≦2, and M represents one or more elements selected from the group consisting of Ti, Ge, Al, Ga, and Zr). In this case, P may be partially substituted with B, Si, or the like in the above chemical formula. For example, a mixture may be used which is obtained by mixing two or more active materials which have different compositions, from lithium-containing phosphate compounds which have a NASICON-type structure, such as Li_{1.5}Al_{0.5}Ge_{1.5}(PO₄)₃ and Li_{1.2}Al_{0.2}Ti_{1.8}(PO₄)₃.

In addition, materials including a crystalline phase of a lithium-containing phosphate compound which has a NASICON-type structure, or glass materials from which crystalline phase of a lithium-containing phosphate compound which has a NASICON-type structure is deposited through a heat treatment may be used as the lithium-containing phosphate compounds which have a NASICON-type structure, for use in the solid electrolyte.

Further, it is possible to use, as the material for use in the solid electrolyte, materials which have ion conductivity and negligible small electron conductivity, besides the lithium-containing phosphate compounds which have a NASICON-type structure. Such materials can include, for example, lithium halide, lithium nitride, lithium oxoate, and derivatives thereof. In addition, the materials can include Li—P—O compounds such as lithium phosphate (Li₃PO₄), LIPON (LiPO₄₋ₓNₓ) with nitrogen introduced into lithium phosphate, Li—Si—O compounds such as Li₄SiO₄, Li—P—Si—O compounds, Li—V—Si—O compounds, compounds which have perovskite-type structures such as La_{0.51}Li_{0.35}TiO_{2.94}, La_{0.55}Li_{0.35}TiO₃, and Li₃ₓLa_{2/3-x}TiO₃, compounds which have a garnet-type structure containing Li, La, and Zr, and sulfides such as 70Li₂S-30P₂S₅, LiGe_{0.25}P_{0.75}S₄, 75Li₂S-25P₂S₅, 80Li₂S-20P₂S₅, and Li₂S—SiS₂.

At least one material for the positive electrode layer 1, solid electrolyte layer 2, or negative electrode layer 3 of the stacked body 10 or 20 of the all-solid battery through the application of the manufacturing method according to the present invention preferably contains a solid electrolyte composed of a lithium-containing phosphate compound which has a NASICON-type structure. In this case, high ion conductivity can be achieved which is essential for battery operation of the all-solid battery. In addition, the case of using, as the solid electrolyte, glass or glass ceramic which has the composition of a lithium-containing phosphate compound of NASICON-type structure can easily achieve a denser sintered body through the viscous flow of the glass phase in the firing step, and it is thus particularly preferable to prepare starting raw materials for the solid electrolyte in the form of glass or glass ceramic.

In addition, at least one material for the positive electrode layer 1 or negative electrode layer 3 of the stacked body 10 or 20 of the all-solid battery through the application of the manufacturing method according to the present invention preferably contains an electrode active material composed of a lithium-containing phosphate compound. In this case, the phase change of the electrode active material or the reaction of the electrode active material with the solid electrolyte in the firing step can be easily suppressed with high temperature stability of the phosphate skeleton, and the capacity of the all-solid battery can be thus increased. In addition, when the electrode active material composed of a lithium-containing phosphate compound is used in combination with the solid electrolyte composed of a lithium-containing phosphate compound of NASICON-type structure, the reaction between the electrode active material and the solid electrolyte can be suppressed in the firing step, and favorable contact between the both can be achieved. Thus, it is particularly preferable to use the materials for the electrode active material and solid electrolyte in combination as described above.

Furthermore, the current collector layer 4 of the stacked body 20 of the all-solid battery through the application of the manufacturing method according to the present invention contains an electron-conducting material. The electron-conducting material preferably contains at least one selected from the group consisting of conductive oxides, metals, and carbon materials.

Next, examples of the present invention will be described specifically. It is to be noted that the following examples will be given by way of example, and the present invention is not to be considered limited to the following examples.

### EXAMPLES

Examples 1 to 13 of all-solid batteries prepared in accordance with the manufacturing method according to the present invention and a comparative example will be described below.

First, in order to prepare all-solid batteries according to Examples 1 to 12 and the comparative example, the following materials were prepared as starting raw materials for the solid electrolyte layer, positive electrode layer, negative electrode layer, and current collector layer.

Prepared were a glass powder with a composition of Li_{1.5}Al_{0.5}Ge_{1.5}(PO₄)₃ as a solid electrolyte material, a powder including a crystalline phase of NASICON-type structure with a composition of Li₃V₂(PO₄)₃ as a positive electrode active material, a titanium dioxide powder of anatase-type crystal structure as a negative electrode active material, a carbon powder as an electron-conducting material, and a glass ceramic powder with a composition of Li_{1.0}Ge_{2.0}(PO₄)₃ as a sintering material.

The materials mentioned above were used to prepare each slurry by the following method.

(Preparation of Slurry)

The following main material, acrylic resin, and alcohol were weighed in proportions by mass at 100:15:140. Then, the acrylic resin was dissolved in alcohol, and then enclosed in a container along with the main material and media, and after stirring, the media were taken out of the container to prepare each slurry.

A solid electrolyte material for solid electrolyte slurry, a powder obtained by mixing a positive electrode active material, an electron-conducting material, and a solid electrolyte material in proportions by mass at 40:10:50 for positive electrode slurry, a powder obtained by mixing a negative electrode active material, an electron-conducting material, and a solid electrolyte material in proportions by mass at 40:10:50 for negative electrode slurry, or a powder by mixing an electron-conducting material and a sintering material in proportions by mass at 10:90 for current collector slurry was used as the main material.

Each slurry obtained was used to prepare each green sheet by the following method.

(Green Sheet Preparation Step)

Each slurry was applied onto a polyethylene terephthalate (PET) film by use of a doctor blade method, dried on a hot plate heated to a temperature of 40° C., formed into the shape of a sheet of 10 μm in thickness, and cut into a size of 25 mm×25 mm to prepare a sheet.

The respective green sheets obtained were used to form a stacked body according to each of Examples 1 to 12 and the comparative example by the following method.

(Stacked Body Formation Step)

### Examples 1 to 5

### Comparative Example

The stacked body 10 was formed through sequential thermocompression bonding by sandwiching the green sheets between two stainless-steel flat plates 11 as shown in FIG. 3 or 4, every time each of the green sheets peeled from the PET film was stacked.

In this case, in the comparative example, the stacked body 10 was formed through sequential thermocompression bonding by sandwiching the stacked green sheets directly between the two stainless-steel flat plates 11 as shown in FIG. 3. In Examples 1 to 5, the stacked body 10 was formed through sequential thermocompression bonding, each with a polyester film 12 varying in surface roughness [μmRa] as shown in Table 1 below, which is interposed between the lower stainless-steel flat plate 11 and the stacked green sheets as shown in FIG. 4. The thermocompression bonding was carried out by heating the stainless-steel flat plates 11 to a temperature of 60° C., and applying a pressure of 2000 kg/cm².

It is to be noted that the stacked body 10 has an electrical cell structure as shown in FIG. 1, which is composed of the positive electrode layer 1 of two positive electrode green sheets, the solid electrolyte layer 2 of five solid electrolyte green sheets, and the negative electrode layer 3 of one negative electrode sheet.

### Examples 6 to 7

The stacked body 10 was formed through sequential thermocompression bonding by sandwiching the green sheets directly between two stainless-steel flat plates 11 as shown in FIG. 3, every time each of the green sheets peeled from the PET film was stacked. The thermocompression bonding was carried out by heating the stainless-steel flat plates 11 to a temperature of 60° C., and applying a pressure of 1000 kg/cm².

Next, in order to adequately enhance the adhesion between the respective green sheets constituting the stacked body 10, pressure was applied with the stacked body 10 sandwiched between the two stainless-steel flat plates 11. In this case, pressure was applied to the stacked body 10, each with a polyester film 12 varying in surface roughness [μmRa] as shown in Table 1 below, which is interposed between the lower stainless-steel flat plate 11 and the stacked body 10 as shown in FIG. 4. While the stainless-steel flat plates 11 were kept at room temperature without heating, a pressure of 2000 kg/cm² was applied.

### Example 8

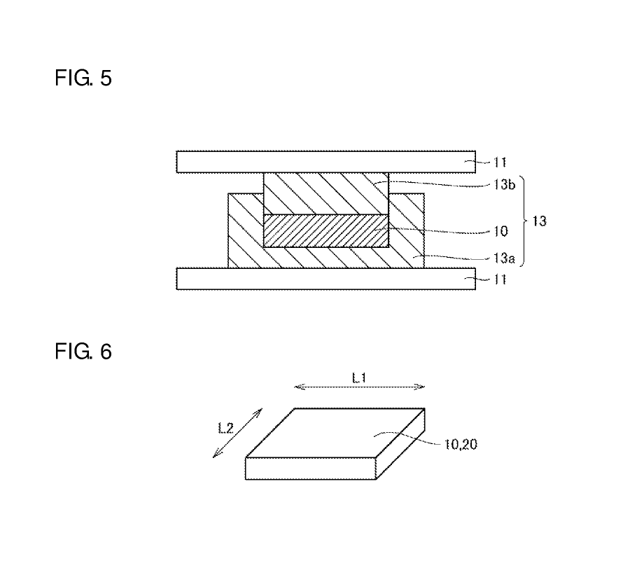

The stacked body 10 was formed through sequential thermocompression bonding by sandwiching stacked green sheets between two stainless-steel flat plates 11 while the sheets housed in a main body 13a of a rigid container 13 is covered with a lid 13b as shown in FIG. 5, with the use of the rigid container 13 in the same shape (25 mm×25 mm) as the green sheets in internal dimension, every time each of the green sheets peeled from the PET film was stacked. The thermocompression bonding was carried out by heating the stainless-steel flat plates 11 to a temperature of 60° C., and applying a pressure of 2000 kg/cm². In this case, after subjected to still standing until the rigid container 13 reached a temperature of 60° C., the pressure was applied.

### Example 9

The stacked body 10 was formed through sequential thermocompression bonding by sandwiching the green sheets directly between two stainless-steel flat plates 11 as shown in FIG. 3, every time each of the green sheets peeled from the PET film was stacked. The thermocompression bonding was carried out by heating the stainless-steel flat plates 11 to a temperature of 60° C., and applying a pressure of 1000 kg/cm².

Next, in order to adequately enhance the adhesion between the respective green sheets constituting the stacked body 10, pressure was applied to the stacked body 10 by sandwiching the stacked body 10 between the two stainless-steel flat plates 11 while the stacked body 10 housed in the main body 13a of the rigid container 13 is covered with the lid 13b as shown in FIG. 5, with the use of the rigid container 13 in the same shape (25 mm×25 mm) as the green sheets in internal dimension. While the stainless-steel flat plates 11 were kept at room temperature without heating, a pressure of 2000 kg/cm² was applied.

### Examples 10 to 12

The stacked body 10 or 20 was formed through sequential thermocompression bonding by sandwiching the green sheets directly between the two stainless-steel flat plates 11 as shown in FIG. 3, every time each of the green sheets peeled from the PET film was stacked. The thermocompression bonding was carried out by heating the stainless-steel flat plates 11 to a temperature of 60° C., and applying a pressure of 1000 kg/cm².

It is to be noted that the stacked body 10 was formed in Example 10. The stacked body 20 was formed in Examples 11 and 12. The stacked body 20 is structured with two electrical cells stacked to be electrically connected in series as shown in FIG. 2, where the two electrical cells are connected in series through the current collector layer 4 composed of two current collector green sheets. It is to be noted each electrical cell is composed of the positive electrode layer 1 of two positive electrode green sheets, the solid electrolyte layer 2 of five solid electrolyte green sheets, and the negative electrode layer 3 of one negative electrode sheet.

Next, in order to adequately enhance the adhesion between the respective green sheets constituting the stacked body 10 or 20, the stacked body 10 or 20 was enclosed in a polyethylene bag in vacuum, and the polyethylene bag was wholly immersed in water at a temperature of 80° C. to apply pressure to the water. A pressure of 180 MPa was applied to the water by isostatic pressing.

The stacked body obtained according to each of Examples 1 to 12 and the comparative example was subjected to firing by the following method.

(Firing Step)

### Examples 1 to 11

### Comparative Example

The stacked body 10 or 20 was cut into a size of 10 mm×10 mm, and subjected to firing while sandwiched between two porous setters. In this case, the stacked body 10 or 20 was subjected to firing while the setters' own weight was added thereto.

Firing was carried out at a temperature of 700° C. in a nitrogen gas atmosphere after the acrylic resin was removed by firing at a temperature of 400° C. in a nitrogen gas atmosphere containing 1 volume % of oxygen.

### Example 12

The stacked body 20 was cut into a size of 10 mm×10 mm, sandwiched between two porous setters, and subjected to firing with a pressure of 20 kg/cm² applied to the setters. In this way, the stacked body 20 was subjected to firing with a pressure of 20 Kg/cm² applied thereto. The other firing conditions are the same as in Examples 1 to 11 and the comparative example.

The stacked body 10 or 20 of the all-solid battery prepared in the way described above was evaluated in the following way.

(Evaluation 1 of Stacked Body)

As shown in FIG. 6, the dimensions L1 and L2 [mm] in the planar direction of the green sheet before the stacking and the dimensions L1 and L2 in the planar direction of the stacked body 10 or 20 after the stacked body formation step were measured, and the elongation percentage [%] was calculated in accordance with the following formula.

(Elongation Percentage)=[{(Sum of Dimensions in Planar Direction of Stacked Body 10 or 20:L1+L2)/2}/{(Sum of Dimensions in Planar Direction of Green Sheet before Stacking:L1+L2)/2}−1]×100

(Evaluation 2 of Stacked Body)

The surface asperity of the stacked body 10 or 20 was visually observed after the stacked body formation step.

(Evaluation 3 of Stacked Body)

A positive electrode terminal and a negative electrode terminal were formed in such a way that a silver paste was applied onto both surfaces of the fired stacked body 10 or 20, and dried while copper lead terminals were buried into the silver paste.

### Examples 1 to 10

### Comparative Example 1

The stacked body 10 of the all-solid battery with the positive and negative electrode terminals attached thereto was charged up to a voltage of 3.2 V at a current of 10 μA in an argon gas atmosphere, and kept for 10 hours at the voltage of 3.2 V. Thereafter, the stacked body was discharged down to a voltage of 0 V at a current of 10 μA to measure the discharge capacity.

### Examples 11 and 12

The stacked body 20 of the all-solid battery with the positive and negative electrode terminals attached thereto was charged up to a voltage of 6.4 V at a current of 10 μA in an argon gas atmosphere, and kept for 10 hours at the voltage of 6.4 V. Thereafter, the stacked body was discharged down to a voltage of 0 V at a current of 10 μA to measure the discharge capacity.

Table 1 shows the evaluation results.

TABLE 1

| | | | Surface | |
|---|---|---|---|---|
| | Elongation | Discharge | Asperity of | Film Surface |
| | Percentage | Capacity | Stacked Body | Roughness |
| | [%] | [μ Ah] | (visual) | [μ mRa] |
| Example 1 | 2.0 | 58 | No | 0.14 |
| Example 2 | 1.2 | 65 | No | 0.21 |
| Example 3 | 0.9 | 67 | No | 0.91 |
| Example 4 | 0.4 | 69 | No | 2.03 |
| Example 5 | 0.1 | 65 | Yes | 3.32 |
| Example 6 | 1.8 | 60 | No | 0.14 |
| Example 7 | 0.6 | 66 | No | 0.91 |
| Example 8 | 0.3 | 68 | No | — |
| Example 9 | 0.6 | 70 | No | — |
| Example 10 | 0.6 | 67 | No | — |
| Example 11 | 0.3 | 68 | No | — |
| Example 12 | 0.1 | 75 | No | — |
| Comparative | 4.1 | 42 | No | — |
| Example | | | | |

From Table 1, it is understood that Examples 1 to 12 where the stacked body after the stacked body formation step has an elongation percentage of 2.0% or less are higher in discharge capacity than the comparative example which has an elongation percentage of 4.1%. From the foregoing, it is understood that the elongation percentage of 2.0% or less in the stacking suppresses cracking due to the elongation of the green sheets in the stacking, reduces the internal resistance of the all-solid battery, and as a result, can achieve a high capacity.

In addition, it is understood that among Examples 1 to 5 with the stacked body formed by applying thermocompression bonding to the green sheets through the interposed film varying in surface roughness, Examples 2 to 5 using the film of 0.21 μmRa or more in surface roughness are particularly high in discharge capacity. However, Example 5 using the film of 3.32 μmRa in surface roughness had asperity (visual) produced at the front and back surfaces of the stacked body, and this asperity was not completely eliminated even after the firing. From the foregoing, it is preferable to form the stacked body by applying thermocompression bonding to the green sheets through the interposed film of 0.21 μmRa or more and 2.03 μmRa or less in surface roughness.

Furthermore, it is understood that as for Examples 6 and 7 with the pressure applied to the stacked body through the interposed film varying in surface roughness, Example 7 using the film of 0.91 μmRa in surface roughness is particularly high in discharge capacity.

It is also understood that the discharge capacity is higher as compared with the comparative example in Examples 8 and 9 with the pressure applied to the green sheets or stacked body in the rigid container, in Examples 10 to 12 with the pressure applied to the stacked body by isostatic pressing, and in Examples 11 and 12 configured to have the two electrical cells stacked in series. In addition, it is understood that Example 12 with the stacked body subjected to firing while being applied with the pressure higher than that in Example 11 is particularly high in discharge capacity.

### Example 13

In order to prepare an all-solid battery according to Example 13, the following materials were prepared as starting raw materials for the solid electrolyte layer, positive electrode layer, negative electrode layer, and current collector layer.

(Synthesis of Sulfide Solid Electrolyte)

Li₂S and P₂S₅ were weighed in a molar ratio of 7:3, and mixed to obtain a 1 g mixture. The obtained mixture was subjected to mechanical milling for 20 hours under the conditions of temperature: 25° C. and rotation speed: 370 rpm in a nitrogen gas in a planetary ball mill, thereby providing whitish yellow glass. The obtained glass was put in a glass airtight container, and heated at 300° C. for 2 hours to obtain a sulfide-based glass ceramic. This sulfide-based glass ceramic was used as a sulfide solid electrolyte material.

(Preparation of Slurry)

The following main material, poly(ethyl methacrylate) (aldrich, molecular weight: 515000), and toluene were weighed in proportions by mass at 25.00:3.75:71.25. Then, the poly(ethyl methacrylate) was dissolved in toluene, and then enclosed in a container along with the main material and media, and after stirring, the media were taken out of the container to prepare each slurry.

A solid electrolyte material for solid electrolyte slurry, a powder obtained by mixing a positive electrode active material, an electron-conducting material, and a solid electrolyte material in proportions by mass at 45:10:45 for positive electrode slurry, or a powder obtained by mixing a negative electrode active material and a solid electrolyte material in proportions by mass at 50:50 for negative electrode slurry was used as the main material. It is to be noted that lithium cobalt oxide was used for the positive electrode active material, whereas graphite was used for the negative electrode active material.

Each slurry obtained was used to prepare each green sheet by the following method.

(Green Sheet Preparation Step)

Each slurry was applied onto a polyethylene terephthalate (PET) film by use of a doctor blade method, dried on a hot plate heated to a temperature of 40° C., formed into the shape of a sheet of 50 μm in thickness, and subjected to punching into a size of 10 mm in diameter to prepare a green sheet.

The respective green sheets obtained were used to form a stacked body according to Example 13 by the following method.

(Stacked Body Formation Step)

Every time each of the green sheets peeled from the PET film was stacked, a pressure of 100 MPa (about 1019.7 kg/cm²) was applied with stacked green sheets housed in a main body 13a of a mold as shown in FIG. 5, with the use of the mold in the same shape as the green sheets in internal dimension (inside diameter: 10 mm). The elongation percentage of the stacked body after the stacked body formation step was measured in the same way as in Examples 1 to 12. The elongation percentage was 0.6%.

Thereafter, the stacked body was taken out of the mold, put in a coin cell of type 2032, and subjected to swage sealing to prepare a sulfide solid battery.

The sulfide solid battery with positive and negative electrode terminals attached thereto was evaluated by a charge-discharge test. The discharge capacity was measured by charging the battery up to a voltage of 4.0 V at a current of 100 μA, and discharging the same down to 0 V at a current of 100 μA. It was confirmed that a sulfide solid battery is achieved which has a discharge capacity of 0.2 mAh.

The embodiments and examples disclosed herein are all to be considered by way of example in all respects, but not restrictive. The scope of the present invention is defined by the claims, but not the embodiments or examples described above, and intended to encompass all modifications and variations within the meaning and scope equivalent to the scope of the claims.

The method for manufacturing an all-solid battery according to the present invention can suppress the increase in the internal resistance of the all-solid battery by limiting the elongation percentage of the stacked body of green sheets to less than or equal to a predetermined value, and increase the battery capacity. Thus, the present invention is useful particularly for the manufacture of all-solid secondary batteries.

### DESCRIPTION OF REFERENCE SYMBOLS

1: positive electrode layer,
2: solid electrolyte layer,
3: negative electrode layer,
4: current collector layer,
10, 20: stacked body,
11: flat plate,
12: film,
13: rigid container.

1. A method for manufacturing an all-solid battery, the method comprising:
preparing a green sheet for at least any one of a positive electrode layer, a negative electrode layer, a solid electrolyte, and a current collector layer; and
stacking the green sheet to form a stacked body and applying pressure so that the stacked body has an elongation percentage of 2.0% or less in a planar direction of the green sheet.

2. The method for manufacturing an all-solid battery according to claim 1, the method further comprising firing the stacked body.

3. The method for manufacturing an all-solid battery according to claim 2, the method further comprising applying pressure to the stacked body while firing.

4. The method for manufacturing an all-solid battery according to claim 1, wherein at least one material for the positive electrode layer, the solid electrolyte layer, or the negative electrode layer contains a solid electrolyte comprising a lithium-containing phosphate compound having a NASICON-type structure.

5. The method for manufacturing an all-solid battery according to claim 1, wherein at least one material for the positive electrode layer or the negative electrode layer contains an electrode active material comprising a lithium-containing phosphate compound.

6. An all-solid battery manufactured by the manufacturing method according to claim 1.

7. A method for manufacturing an all-solid battery, the method comprising:
preparing a first green sheet for at least any one of a positive electrode layer and a negative electrode layer;
preparing a second green sheet for at least any one of a solid electrolyte layer and a current collector layer; and
stacking the first green sheet and the second green sheet to form a stacked body and applying pressure so that the stacked body has an elongation percentage of 2.0% or less in a planar direction of the first and second green sheets.

8. The method for manufacturing an all-solid battery according to claim 7, wherein the first green sheet and the second green sheet are stacked through a planar member of 0.21 μmRa or more and 2.03 μmRa or less in surface roughness.

9. The method for manufacturing an all-solid battery according to claim 7, wherein the stacked body is formed through a planar member of 0.21 μmRa or more and 2.03 μmRa or less in surface roughness.

10. The method for manufacturing an all-solid battery according to claim 7, wherein the first green sheet and second green sheet housed in a rigid container when the stacked body is formed.

11. The method for manufacturing an all-solid battery according to claim 7, wherein the pressure is applied to the stacked body by isostatic pressing.

12. The method for manufacturing an all-solid battery according to claim 7, wherein a pressure of 500 kg/cm² or more and 5000 kg/cm² or less is applied to the first green sheet and the second green sheet, or to the stacked body.

13. The method for manufacturing an all-solid battery according to claim 7, wherein, while applying the pressure to the first green sheet and the second green sheet, or to the stacked body, a temperature of 20° C. or higher and 100° C. or lower is maintained.

14. The method for manufacturing an all-solid battery according to claim 7, wherein green sheets for the positive electrode layer, the solid electrolyte layer, and the negative electrode layer are stacked to form the stacked body having an electrical cell structure.

15. The method for manufacturing an all-solid battery according to claim 14, wherein more than one of the stacked body having the electrical cell structure are stacked while interposing the current collector layer therebetween.

16. The method for manufacturing an all-solid battery according to claim 7, the method further comprising firing the stacked body.

17. The method for manufacturing an all-solid battery according to claim 16, the method further comprising applying pressure to the stacked body while firing.

18. The method for manufacturing an all-solid battery according to claim 7, wherein at least one material for the positive electrode layer, the solid electrolyte layer, or the negative electrode layer contains a solid electrolyte comprising a lithium-containing phosphate compound having a NASICON-type structure.

19. The method for manufacturing an all-solid battery according to claim 7, wherein at least one material for the positive electrode layer or the negative electrode layer contains an electrode active material comprising a lithium-containing phosphate compound.

20. An all-solid battery manufactured by the manufacturing method according to claim 7.
